(19) United States
(12) Patent Application Publication
(10) Pub. No.: US 2022/0407813 A1
(43) Pub. Date: Dec. 22, 2022

(54) APPARATUSES, SYSTEMS, AND METHODS FOR IMPLIED SEQUENCE NUMBERING OF TRANSACTIONS IN A PROCESSOR-BASED SYSTEM

(71) Applicant: Ampere Computing LLC, Santa Clara, CA (US)

(72) Inventors: Matthew Robert Erler, Portland, OR (US); Robert James Safranek, Portland, OR (US); Robert Joseph Toepfer, Portland, OR (US); Sandeep Brahmadathan, Dublin, CA (US); Shailendra Ramrao Chavan, Brentwood, CA (US); Jonglih Yu, Sunnyvale, CA (US)

(21) Appl. No.: 17/349,379

(22) Filed: Jun. 16, 2021

(51) Int. Cl. H04L 12/863; H04L 1/20; H04L 1/00

(52) U.S. Cl. CPC H04L 47/624; H04L 1/201; H04L 1/0082

(57) ABSTRACT

Apparatuses, systems, and methods for implied sequence numbering of transactions in a processor-based system. The processor-based system includes a transmit circuit configured to generate an implied sequence number for each entry to be transmitted as a packet. The transmit circuit is configured to generate a packet to be transmitted based on an entry, wherein the packet including the payload information and the transmit check value based on the implied sequence number and associated with the entry. In this manner, including an individual sequence number with every transmitted packet may be reduced or avoided to reduce or avoid consuming bandwidth on the communications interface, as the bits used by the sequence number could ordinarily be used for data transmission instead. A receiver circuit is configured to receive the transmitted packet including the payload and the transmit check value, wherein the transmit check value is based on the transmit sequence number.

### BACKGROUND

### I. Field of the Disclosure

The technology of the disclosure relates generally to transactions over a communication interface, and specifically to using an implied sequence numbering for transactions in a processor-based system.

II. Background

Processor-based systems may conventionally include a plurality of individual components, whether on a monolithic die, on multiple dies which are integrated together in a package, or across multiple dies or packages on a platform or motherboard. In order to allow such individual components to communicate with one another, they may be coupled together with a communications interface. Such a communications interface may permit data to be transferred to and from individual components. One conventional interface for such data transmission is the Peripheral Component Interconnect Express bus (PCIe), which provides relatively high-speed serial communications between components of a processor-based system. Communications interfaces with these characteristics, such as PCIe, may conventionally provide a mechanism to handle errors that may occur during transmissions (in addition to defining various signaling protocols and layers associated with the interface). Further, such communications interfaces may support messages of varying lengths, and may further allow large messages to be divided up into some number of smaller packets of data which may be transmitted individually via the communications interface and then reassembled by the receiver in order to reconstruct the entire message.

In order to support messages of varying length, and particularly messages that may span multiple individual packets, each packet conventionally includes metadata related to the message for which the packet includes a portion. This metadata can include, but is not limited to, an indication of the length of the packet, a sequence number which identifies which packet in a multiple packet sequence a particular packet is, and data quality information (such as a CRC value, parity value, ECC value, or other error checking or correction information). The sequence number allows the receiver of the packet to both reassemble the original message (because the order of the multiple packets can be determined from the sequence numbers), and to provide a precise error indication to the transmitter when necessary (because it can identify a specific packet sequence number as being affected by an error). This error information may permit the transmitter to take corrective action, which may conventionally include replaying the transmission of the packet associated with the sequence number that was affected by an error. Thus, the conventional approach enables error checking and error correction by a transmitter and receiver. However, including an individual sequence number with every packet also consumes bandwidth on the communications interface, as the bits used by the sequence number could ordinarily be used for data transmission instead.

### SUMMARY OF THE DISCLOSURE

Aspects disclosed in the detailed description include apparatuses, systems, and methods for implied sequence numbering of transactions in a processor-based system. In exemplary aspects, the processor-based system includes a transmit circuit that is configured to generate a packet to be transmitted. The transmit circuit is configured to generate an implied sequence number for each entry to be transmitted as a packet. The transmit circuit is configured to generate a packet to be transmitted based on an entry, wherein the packet including the payload information and the transmit check value based on the implied sequence number and associated with the entry. In this manner, including an individual sequence number with every transmitted packet may be reduced or avoided to reduce or avoid consuming bandwidth on the communications interface, as the bits used by the sequence number could ordinarily be used for data transmission instead. A receiver circuit in the same or different processor-based is configured to receive the transmitted packet including the payload and the transmit check value, wherein the transmit check value is based on the transmit sequence number. The receive circuit is then configured to generate an expected check value based on the receive sequence number, and perform a comparison of the transmit check value and the expected check value.

In one exemplary aspect, a processor-based system is provided. The processor-based system comprises a transmit circuit. The transmit circuit comprises a replay buffer including a plurality of entries, each entry including payload information and associated with an implied sequence number. The transmit circuit also comprises a data quality check generation circuit configured to receive an implied sequence number associated with an entry of the replay buffer and to generate a transmit check value based on the implied sequence number. The transmit circuit is configured to generate a packet based on an entry of the replay buffer, the packet including the payload information and the transmit check value associated with the entry.

In one exemplary aspect, a processor-based system is provided. The processor-based system comprises a receive circuit configured to receive a packet over a communications interface, wherein the packet includes a transmit check value. The receive circuit comprises an implied sequence number tracking circuit configured to track a current implied sequence number associated with the packet. The receive circuit also comprises a data quality check circuit configured to receive the packet and the current implied sequence number, generate an expected check value based on the current implied sequence number, and compare the expected check value with the transmit check value received in the packet. The receive circuit also comprises a payload write circuit configured to write the payload information in the packet into a receive buffer if the comparison between the expected check value and the transmit check value received in the packet indicates a match. The receive circuit also comprises a non-acknowledge generation circuit configured to generate an error indication if the comparison between the expected check value and the transmit check value received in the packet does not indicate a match.

In another exemplary aspect, a processor-based system is provided. The processor-based system comprises a means for transmitting, wherein the means for transmitting comprises a means for storing a plurality of entries, each entry including payload information and associated with an implied sequence number, and a means for generating a data quality check configured to receive an implied sequence number associated with an entry of the means for storing a plurality of entries and to generate a transmit check value based on the implied sequence number. The means for transmitting further comprises a means for generating a packet based on an entry of the means for storing a plurality of entries, the packet including the payload information and the transmit check value associated with the entry.

In another exemplary aspect, a processor-based system is provided. The processor-based system comprises a means for receiving, wherein the means for receiving comprises a means for receiving a packet over a means for communication, the packet including a transmit check value. The means for receiving further comprises a means for tracking an implied sequence number associated with the packet, a means for checking data quality of the received packet and the current implied sequence number, a means for generating an expected check value based on the current implied sequence number, a means for comparing the expected check value with the transmit check value received in the packet, and a means for writing the payload information in the packet into a means for storing if the comparison between the expected check value and the transmit check value received in the packet indicates a match, and a means for generating a non-acknowledgement as an error indication if the comparison between the expected check value and the transmit check value received in the packet does not indicate a match.

In another exemplary aspect, a method of performing transactions using an implied sequence number is provided. The method comprises generating a transmit check value at a transmit circuit based on an implied sequence number. The method also comprises generating a packet including a payload and the transmit check value at the transmit circuit. The method also comprises transmitting the packet.

In another exemplary aspect, a method of performing transactions using an implied sequence number is provided. The method comprises receiving a packet including a payload and a transmit check value, the transmit check value based on a transmit sequence number. The method also comprises generating an expected check value based on a receive sequence number. The method also comprises performing a comparison of the transmit check value and the expected check value.

### BRIEF DESCRIPTION OF THE FIGURES

FIG. 1A is a block diagram of a conventional packet format for a communications interface;

FIG. 1B is a block diagram of an implied sequence numbering packet format for a communications interface;

FIG. 2 is a block diagram of an exemplary system including a communications interface that implements implied sequence numbering;

FIG. 3A is a block diagram of a method for generating and transmitting a packet based on an implied sequence numbering;

FIG. 3B is a block diagram of a method for receiving and checking a packet based on an implied sequence numbering; and

FIG. 4 is a block diagram of an exemplary processor-based system including a processor having a communications interface that implements implied sequence numbering.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include apparatuses, systems, and methods for implied sequence numbering of transactions in a processor-based system.

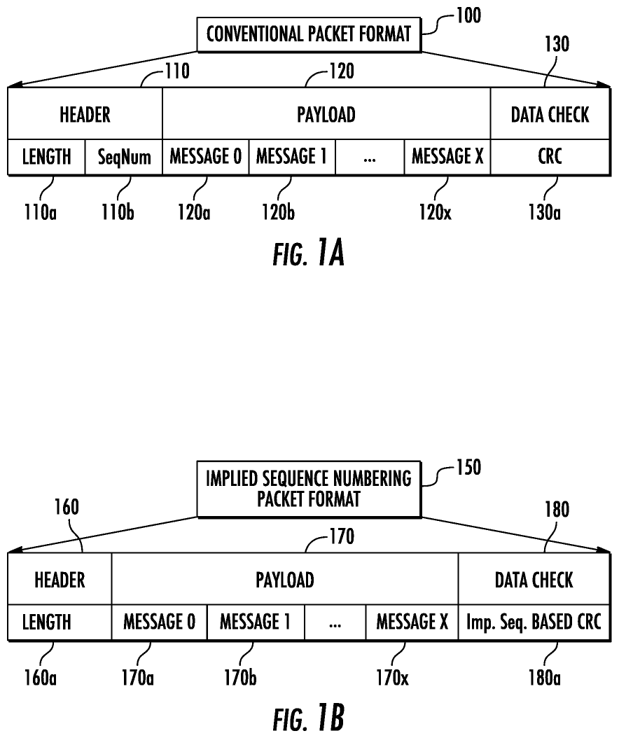

FIG. 1A is a block diagram of an exemplary conventional packet format 100 for a communications interface. The conventional packet format 100 includes a header portion 110, a payload portion 120, and a data check portion 130. The header portion 110 further includes length information 110a and a sequence number 110b, which may allow a receiver to reassemble a message of which an individual packet having the conventional packet format 100 is a part, and which may further allow a receiver to provide precise error information to a transmitter based on the sequence number 110b as described above. The payload portion 120 includes one or more message portions 120a-120x. The data check portion 130 includes information that allows a receiver to perform data integrity checking, which in the illustrated aspect may be CRC information 130a (although, as discussed above, other types of data integrity information may also be used). As can be seen, including the sequence number 110b consumes bits in the packet which could otherwise be used for data transmission, or could be omitted to reduce the amount of data to be transmitted over an associated communications interface.

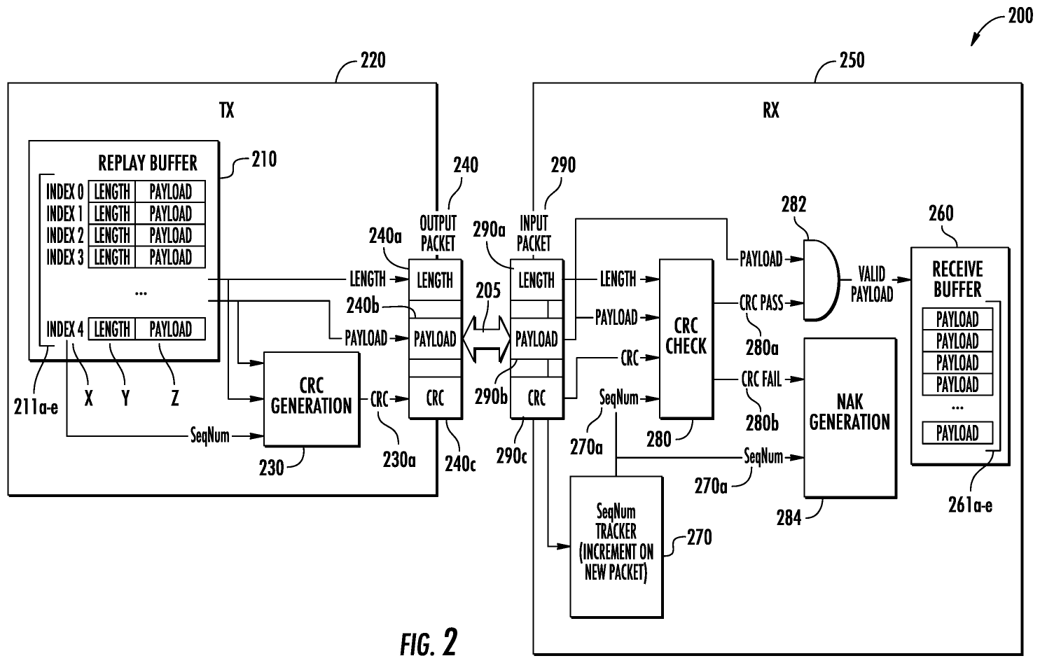

In this regard, FIG. 1B is a block diagram of an implied sequence numbering packet format 150 for a communications interface, as will be discussed in greater detail herein. Similar to the conventional packet format 100, the implied sequence numbering packet format 150 includes a header portion 160, a payload portion 170, and a data check portion 180. The payload portion 170 may include one or more message portions 170a-170x. However, the header portion 160 may include only length information 160a, but not a sequence number as in the conventional packet format 100. Instead, the implied sequence numbering packet format 150 includes implied sequence number-based CRC information 180a in the data check portion 180, which allows a receiver to both perform data integrity checking and to derive a sequence number for a particular packet having the implied sequence numbering packet format 150. As will be described in further detail with regard to FIGS. 2-4, various types of data integrity information may be combined with a sequence number by a transmitter of a packet such that a receiver of the packet can use the data check portion 180 to both perform data integrity checking and to determine a sequence number for the packet. Including the sequence number as part of the data check portion (e.g., using the sequence number to generate the implied sequence number-based CRC information 180a) may reduce or eliminate a number of bits used for sequence number information for the implied sequence numbering packet format 150 as compared to the conventional packet format 100.

Those having skill in the art will recognize that, as described above, although the data check portion 180 is illustrated as a CRC-based data check, other data integrity checking information types may be used, so long as they can be combined with sequence number information by the transmitter in a way that allows the receiver to derive the sequence number information, and to perform any desired data integrity checking. Although the header portion 160 in FIG. 1B has been described as including length information 160a, the header portion 160 may include other types of information and may not include length information 160a in some aspects (e.g., length information 160a may be included in aspects where the implied sequence numbering packet format 150 is a variable-length format, and may not be included in aspects where the implied sequence numbering packet format 150 is a fixed-length format), and these aspects are within the scope of the teachings of the present disclosure. Likewise, the order of the header portion 160, payload portion 170, and data check portion 180 in the implied sequence numbering packet format 150 is merely for convenience of illustration and not by way of limitation, and any order of the header portion 160, payload portion 170, and data check portion 180 may be selected.

In this regard, FIG. 2 is a block diagram of an exemplary system 200 including a communications interface that implements implied sequence numbering. The processor-based system 200 may include a transmit circuit 220 and a receive circuit 250 coupled together by a communications interface 205. The transmit circuit 220 may further include a replay buffer 210 which is configured to store information regarding pending transactions between the transmit circuit 220 and the receive circuit 250. The replay buffer 210 includes a plurality of entries 211a-211e, each of which corresponds to a transaction which may be performed over the communications interface 205. Each of the entries 211a-211e includes an index number X, length information Y, and payload information Z. The transmit circuit 220 may further include a CRC generation circuit 230 which is configured to receive information associated with an entry of the entries 211a-211e which is to be transmitted (e.g., the length information Y and the payload information Z in the illustrated aspect), including the associated index number X, and to generate a CRC value 230a based on the information and the associated index number X from which the receive circuit 250 can perform data integrity checking and determine a sequence number for a transmitted packet. The transmit circuit 220 may generate an output packet 240 including the length information Y and payload information Z from one of the entries 2111a-211e of the replay buffer 210, as well as the CRC value 230a generated by the CRC generation circuit 230 associated with the index number X, length information Y, and payload information Z for the specific one of the entries 211a-211e which is being assembled into the output packet 240. Once the output packet 240 has been assembled, in one aspect it may correspond to the implied sequence numbering packet format 150 as described above in reference to FIG. 113 (i.e., including length information 240a, payload 240b, and implied sequence number-based CRC information 240c), and it may be transmitted to the receive circuit 250 over the communications interface 205. The transmit circuit 220 may assemble and transmit packets generated from the entries 211a-211e in the order of the associated index number(s) X for each of the entries 211a-211e (i.e., the index number X corresponds to the implied sequence number tracked by the receive circuit 250, as will be described further below).

The receive circuit 250 may receive an input packet 290 (which in an illustrated aspect may correspond to the output packet 240 as transmitted by the transmit circuit 220) over the communications interface 205, and the input packet 290 may include length information 290a, payload 290b, and implied sequence number-based CRC information 290c. The receive circuit 250 includes a sequence number tracking circuit 270 and a CRC check circuit 280. At the beginning of a sequence of transactions, the sequence number tracking circuit 270 is initialized to a starting sequence number (which may correspond to a starting index number in the transmit circuit 220, such that the transmit circuit 220 and the receive circuit 250 have a same starting value upon which the implied sequence number-based CRC information 240c/290c, may be generated and compared). The sequence number tracking circuit 270 identifies when a new packet (such as input packet 290) has been received by the receive circuit 250, provides a current implied sequence number 270a to the CRC check circuit 280, and increments the current implied sequence number 270a to keep the receive circuit 250 synchronized with the transmit circuit 220 (i.e., the incremented current implied sequence number 270a will correspond to the next index number X for the subsequent packet that will be assembled and transmitted by the transmit circuit 220 to the receive circuit 250).

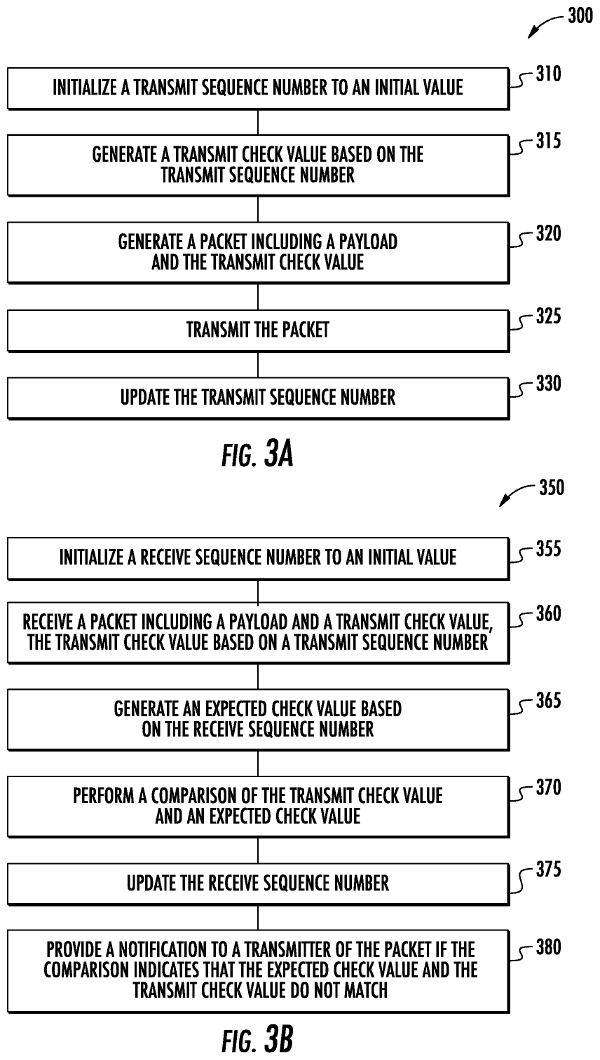

The CRC check circuit 280 receives the length information 290a, payload 290b, implied sequence number-based CRC information 290c, and the current implied sequence number 270a, and uses the above information to perform a comparison of the received implied sequence number-based CRC information 290c with a generated expected implied sequence number-based CRC value. The CRC check circuit 280 may generate the expected implied sequence number-based CRC value based on the current implied sequence number 270a, the length information 290a, and the payload 290b, as will be described further with reference to FIG. 3B. Based on the comparison, the CRC check circuit 280 generates a CRC pass signal 280a and a CRC fail signal 280b. A payload write circuit 282 receives the payload 290b and the CRC pass signal 280a, and if the CRC pass signal 280a indicates that the implied sequence number-based CRC information 290c matches the expected implied sequence number-based CRC value, the payload 290b is written into a receive buffer 260 in one of a plurality of entries 261a-261e. A non-acknowledge generation circuit 284 receives the current implied sequence number 270a and the CRC fail signal 280b, and if the CRC fail signal 280b indicates that the implied sequence number-based CRC information 290c does not match the expected implied sequence number-based CRC value, an indication may be provided back to the receive circuit 250 that the packet corresponding to the current implied sequence number 270a was not properly received, and that corrective action should be taken (e.g., the transmit circuit 220 may re-send the packet corresponding to that current implied sequence number 270a and all subsequent packets, and the sequence number tracking circuit 270 may be set to a value corresponding to the current implied sequence number 270a for the packet).

FIG. 3A is a block diagram of a method 300 for generating and transmitting a packet based on an implied sequence numbering. The method may begin in block 310, by initializing a transmit sequence number to an initial value, For example, with respect to FIG. 2, this may include choosing an entry of the entries 211a-211e of the replay buffer 210 to transmit in an order according to the index number X (i.e., choosing an entry having an index number which matches an initial implied sequence number as tracked by the sequence number tracking circuit 270 as a first entry to transmit). The method proceeds to block 315 by generating a transmit check value based on the transmit sequence number. For example, with respect to FIG. 2, the index number X associated. with the specific entry of the entries 211a-211e being assembled into output packet 240 is provided to the CRC generation circuit 230, which generates a CRC value 230a based on the index number X for that specific entry (and other information associated with the entry).

The method then proceeds to block 320, by generating a packet including a payload and the transmit check value. For example, with respect to FIG. 2, this may include generating the output packet 240 to include the payload information Z from a specific entry of the entries 211a-211e and the CRC value 230a based on the index number X for that specific entry. The method then proceeds to block 325, by transmitting the packet. For example, the transmit circuit 220 transmits the generated output packet 240 over the communications interface to the receive circuit 250.

The method may further proceed to block 330, by updating the transmit sequence number. For example, with respect to FIG. 2, this may include preparing to generate a new output packet 240 based on a next entry of the entries 211a-211e as determined by the index number(s) X for each of the entries 211a-211e.

FIG. 3B is a block diagram of a method 350 for receiving and checking a packet based on an implied sequence numbering. The method may begin in block 355, by initializing a receive sequence number to an initial value. For example, with respect to FIG. 2, the implied sequence number tracking circuit 270 may initialize the current implied sequence number 270a to an initial value which matches the index number X for a first entry of the replay buffer 210 that will be assembled into a packet by the transmit circuit 220. The method continues in block 360, by receiving a packet including a payload and a transmit check value, the transmit check value based on a transmit sequence number. For example, with respect to FIG. 2, the receive circuit 250 receives the input packet 290 which includes the payload 290b and the implied sequence number-based CRC information 290c. The method continues in block 365, by generating an expected check value based on the receive sequence number. For example, with respect to FIG. 2, the current implied sequence number 270a is provided to the CRC check circuit 280, which generates an expected implied sequence number-based CRC value based on the current implied sequence number 270a, the payload 290b, and the length information 290a.

The method continues in block 370, by performing a comparison of the transmit check value and the expected check value. For example, with respect to FIG. 2, the CRC check circuit 280 compares the transmitted implied sequence number-based CRC information 290c with the generated expected implied sequence number-based CRC value based on the current implied sequence number 270a, the length information 290a, and the payload 290b.

The method may continue in block 375, by updating the receive sequence number. For example, with respect to FIG. 2, the current implied sequence number may be incremented when the CRC pass signal 280a indicated that the transmitted implied sequence number-based CRC information 290c matches the generated expected implied sequence number-based CRC value. The method may further continue in block 380, by providing a notification to a transmitter of the packet if the comparison indicates that the expected check value and the transmit check value do not match. For example, with respect to FIG. 2, if the CRC fail signal 280b indicates that the implied sequence number-based CRC information 290c does not match the expected implied sequence number-based CRC value, an error indication may be provided back to the transmit circuit 220 that the packet corresponding to the current implied sequence number 270a was not properly received, and that corrective action should be taken.

Those having skill in the art will appreciate that other aspects where the allocation of requests is controlled based on different parameters are within the scope of the teachings of the present disclosure. For example, in the case where an error indication is provided back to the transmit circuit 220 that the packet corresponding to the current implied sequence number 270a was not properly received, in one aspect the error indication may include a portion that directly identifies the sequence number of the packet (i.e., for replay requests, the sequence number may not necessarily be implied). In another aspect, the sequence number may not be included in the error indication to the transmit circuit 220, but instead only the implied sequence number-based CRC information 290c may be provided, and the transmit circuit 220 may perform a comparison of the error indication received from the receiver against all outstanding packets to determine which of the entries 211a-211e is associated with the error indication.

The exemplary system including a communications interface that implements implied sequence numbering according to aspects disclosed herein and discussed with reference to FIGS. 1-3 may be provided in or integrated into any processor-based device. Examples, without limitation, include a server, a computer, a portable computer, a desktop computer, a mobile computing device, a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a wearable computing device (e.g., a smart watch, a health or fitness tracker, eyewear, etc.), a personal digital assistant (PIM), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

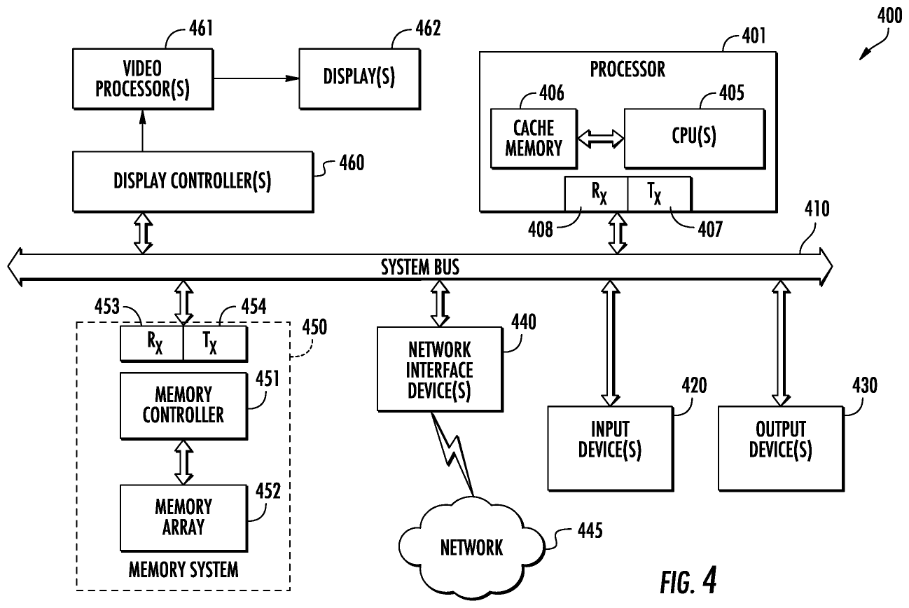

In this regard, FIG. 4 is a block diagram of an exemplary processor-based system 400 including a processor having a communications interface that implements implied sequence numbering as illustrated and described with respect to FIGS. 1-3. In this example, the processor-based system 400 includes a processor 401 which may include the elements of the processor-based system 200, and as such may include a communications interface that implements implied sequence numbering as illustrated and described with respect to FIGS. 1-3. The CPU(s) 405 may be coupled to a cache memory system 406. The CPU(s) 405 may be an initiator device. The CPU(s) 405 is coupled to a system bus 410 and can intercouple initiator and target devices included in the processor-based system 400. As is well known, the CPU(s) 405 communicates with these other devices by exchanging address, control, and data information over the system bus 410. For example, the CPU(s) 405 can communicate bus transaction requests to a memory controller 451 as an example of a target device. Although not illustrated in FIG. 4, multiple system buses 410 could be provided, wherein each system bus 410 constitutes a different fabric. The system bus may correspond to the communications interface 205, in one aspect, and the processor 401 may include a transmitter 407 and a receiver 408 which may be configured to transmit and receive packets as described with reference to FIGS. 1-3 above with other components of the processor-based system 400.

Other initiator and target devices can be connected to the system bus 410. As illustrated in FIG. 4, these devices can include additional processors such as the processor 401 (not illustrated), a memory system 450, one or more input devices 420, one or more output devices 430, one or more network interface devices 440, and one or more display controllers 460, as examples, and these devices may be included on a single die, may be integrated together in a single package, or may be included in multiple dies and packages and may be coupled together by the system bus 410 (or additional system busses as describe above) on a platform or motherboard. The input device(s) 420 can include any type of input device, including, but not limited to, input keys, switches, voice processors, etc. The output device(s) 430 can include any type of output device, including, but not limited to, audio, video, other visual indicators, etc. The network interface device(s) 440 can be any devices configured to allow exchange of data to and from a network 445. The network 445 can be any type of network, including, but not limited to, a wired or wireless network, a private or public network, a local area network (LAN), a wireless local area network (MAN), a wide area network (WAN), a BLUETOOTH™ network, and the Internet. The network interface device(s) 440 can be configured to support any type of communications protocol desired. The memory system 450 can include the memory controller 451 coupled to one or more memory arrays 452, and can further include a transmitter 454 and a receiver 453 which may be configured to transmit and receive packets as described with reference to FIGS. 1-3 above with other components of the processor-based system 400.

The CPU(s) 405 may also be configured to access the display controller(s) 460 over the system bus 410 to control information sent to one or more displays 462. The display controller(s) 460 sends information to the display(s) 462 to be displayed via one or more video processors 461, which process the information to be displayed into a format suitable for the display(s) 462. The display(s) 462 can include any type of display, including, but not limited to, a cathode ray tube (CRT), a liquid crystal display (LCD), a plasma display, a light emitting diode (LED) display, etc.

Although only the processor 401 and the memory system 450 have been illustrated as including transmitter(s) and receiver(s) as described with reference to FIGS. 1-3 above, those having skill in the art will appreciate that this is merely for ease of illustration, and that similar transmitter(s) and receiver( )may be included in any or all of the components of the processor-based system 400 which may communicate over the system bus 410, or over other communications interfaces that may not be illustrated.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The initiator devices and target devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read. Only Memory (ROM), Electrically Programmable ROM (EPROM), Electrically Erasable Programmable ROM (EEPROM), registers, a hard disk, a removable disk, a CD-ROM, or any other form of computer readable medium known in the art, An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A processor-based system, comprising:
a transmit circuit comprising:
a replay buffer including a plurality of entries, each entry including payload information and associated with an implied sequence number; and
a data quality check generation circuit configured to receive an implied sequence number associated with an entry of the replay buffer and to generate a transmit check value based on the implied sequence number,
the transmit circuit configured to generate a packet based on an entry of the replay buffer, the packet including the payload information and the transmit check value associated with the entry,

2. The processor-based system of claim 1, wherein the transmit circuit is further configured to provide the packet to a communications interface.

3. The processor-based system of claim 1, wherein the transmit circuit is further configured to:
receive an indication from a receive circuit which received the packet over the communications interface that the packet was not properly received; and
re-send the packet in response to the indication.

4. The processor-based system of claim 1, wherein the data quality check generation circuit is configured to generate the transmit check value as one of a cyclic redundancy check (CRC) value, a parity value, or an error correction code (ECC) value.

5. The processor-based system of claim 1, wherein the implied sequence number is an index number associated with the entry of the replay buffer, and where an initial index is selected to match an initial implied sequence number of a receive circuit.

6. The processor-based system of claim 1, wherein each entry of the replay buffer includes length information and wherein the packet is a variable-length packet.

7. The processor-based system of claim 1, integrated into an integrated circuit (IC).

8. The processor-based system of claim 2, further integrated into a device selected from the group consisting of: a server, a computer, a portable computer, a desktop computer, a mobile computing device, a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a wearable computing device (e.g., a smart watch, a health or fitness tracker, eyewear, etc.), a personal digital assistant (PDM), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

9. A processor-based system comprising:
a receive circuit configured to receive a packet over a communications interface, the packet including a transmit check value, and the receive circuit comprises:
an implied sequence number tracking circuit configured to track a current implied sequence number associated with the packet;
a data quality check circuit configured to receive the packet and the current implied sequence number, generate an expected check value based on the current implied sequence number, and compare the expected check value with the transmit check value received in the packet;
a payload write circuit configured to write the payload information in the packet into a receive buffer if the comparison between the expected check value and the transmit check value received in the packet indicates a match; and
a non-acknowledge generation circuit configured to generate an error indication if the comparison between the expected check value and the transmit check value received in the packet does not indicate a match.

10. The processor-based system of claim 9, wherein the implied sequence number tracking circuit is further configured to:
initialize the current implied sequence number to an initial value synchronized with an initial implied sequence number of an associated transmit circuit; and
set the current implied sequence number to a value corresponding to the implied sequence number of a packet for which the expected check value and the transmit check value received in the packet did not match.

11. A processor-based system, comprising:
means for transmitting, the means for transmitting further comprising:
means for storing a plurality of entries, each entry including payload information and associated with an implied sequence number; and
means for generating a data quality check configured to receive an implied sequence number associated with an entry of the means for storing a plurality of entries and to generate a transmit check value based on the implied sequence number,
the means for transmitting further comprising a means for generating a packet based on an entry of the means for storing a plurality of entries, the packet including the payload information and the transmit check value associated with the entry.

12. A processor-based system comprising:
means for receiving a packet over a means for communication, the packet including a transmit check value;
the means for receiving further comprising:
means for tracking an implied sequence number tracking associated with the packet;
means for checking data quality in the received packet and the current implied sequence number;
means for generating an expected check value based on the current implied sequence number;
means for comparing the expected check value with the transmit check value received in the packet;
means for writing the payload information in the packet into a means for storing if the comparison between the expected check value and the transmit check value received in the packet indicates a match; and
means for generating a non-acknowledgement as an error indication if the comparison between the expected check value and the transmit check value received in the packet does not indicate a match.

13. A method of performing transactions using an implied sequence number, comprising:
generating a transmit check value at a transmit circuit based on an implied sequence number;
generating a packet including a payload and the transmit check value at the transmit circuit; and
transmitting the packet.

14. The method of claim 13, further comprising initializing the implied sequence number to an initial value, the initial value synchronized with an initial implied sequence number of an associated receive circuit.

15. The method of claim 14, further comprising updating the implied sequence number.

16. The method of claim 13, wherein the transmit check value is one of a cyclic redundancy check (CRC) value, a parity value, or an error correction code (ECC) value.

17. A method of performing transactions using an implied sequence number, comprising:
receiving a packet including a payload and a transmit check value, the transmit check value based on a transmit sequence number;
generating an expected check value based on a receive sequence number; and
performing a comparison of the transmit check value and the expected check value.

18. The method of claim 17, further comprising initializing the receive sequence number to an initial value, the initial value synchronized with an initial implied sequence number of an associated transmit circuit.

19. The method of claim 18, further comprising updating the receive sequence number to keep the receive sequence number synchronized with a next expected transmit sequence number.

20. The method of claim 17, further comprising:
writing the payload into a receive buffer if the comparison of the transmit check value and the expected check value indicates a match; and
generating an error indication associated with the receive sequence number if the comparison of the transmit check value and the expected check value does not indicate a match.
